(19) United States
(12) Patent Application Publication
(10) Pub. No.: US 2020/0308025 A1
(43) Pub. Date: Oct. 1, 2020

(54) UV FLUID DISINFECTION MODULE

(71) Applicant: RayVio Corporation, Hayward, CA (US)

(72) Inventors: Douglas A. Collins, Hayward, CA (US); Li Zhang, San Ramon, CA (US); Wei Keat Chai, Hayward, CA (US); Faisal Sudradjat, Hayward, CA (US); Yitao Liao, Redwood City, CA (US)

(21) Appl. No.: 16/363,949

(22) Filed: Mar. 25, 2019

(51) Int. Cl. C02F 1/32

(52) U.S. Cl. CPC C02F 1/325; C02F 2201/3222; C02F 2201/3223; C02F 2201/324; C02F 2201/3228

(57) ABSTRACT

A UVC disinfection system is described where incoming fluid, such as water, is directed onto a transparent window in a vertical disinfection chamber. The incoming water is directed downward by a channel at an acute angle (e.g., 10-20 degrees) with respect to a central axis of the disinfection chamber and impinges on the window at an angle almost perpendicular to the window surface. One or more UVC LEDs are optically coupled to the window. The water impinging on the window becomes agitated due to the severe redirection and interaction with water already in the chamber. This randomizes (mixes) the water in the area where there is the highest UVC power. The UVC LEDs direct light along the central axis of the cylindrical chamber for maximum exposure of the water to the UVC light. Disinfection efficiency is therefore increased.

### FIELD OF THE INVENTION

This invention relates to disinfection systems for purifying water or other fluids and, in particular, to a technique for disinfecting fluids using an ultra-violet (UV) light source.

### BACKGROUND

Applicant's own U.S. Pat. No. 9,540,252, incorporated herein by reference, describes the UV disinfection system shown in FIG. 1. In FIG. 1, water 10 enters the left side of the disinfection chamber 12 and flows through a first porous reflector 14, such as made of polished aluminum or stainless steel. The water 10 then flows through a second porous reflector 16 and exits the chamber 12. Water pipes may connect to each end of the chamber 12. A UV light source 18, such as one or more UV light emitting diodes (LEDs) emitting UVC wavelengths, is supported on a sidewall of the chamber 12. The UV light source 18 may be inside the chamber 12 or inject UV light through a transparent window. The chamber 12 may have a UV-reflective inner wall such as created by polished metal or a UV-reflective Teflon coating. The chamber 12 forms a straight cylinder.

As shown, the emitted UV light 20 repeatedly reflects off the porous reflectors 14/16 and the inside wall of the chamber 12. The porous reflectors 14 and 16 also agitate the water 10 to randomize it. The multiple reflections and the randomizing of the water 10 improve the disinfection efficiency. One possible determination of disinfection efficiency is the time the water 10 is needed to reside between the porous reflectors 14/16 before a specified percentage of the water 10 (e.g., 99%) becomes disinfected. This may be on the order of one second. It is desirable that this required time be reduced to increase the quantity of water that can be disinfected per unit time, given a certain UV output power.

Although the system of FIG. 1 is an improvement over previous UV disinfection systems, it is desirable to further improve the disinfection efficiency of a disinfection chamber in a fluid path.

### SUMMARY

A UVC disinfection system is described where incoming fluid, such as water, is directed onto a bottom transparent window in a generally vertical disinfection chamber at a downward acute angle (e.g., less than 45 degrees). Therefore, the water impacts the window at an angle almost perpendicular to its surface. One or more UVC LEDs are optically coupled to the window. The water impinging on the window at the acute angle becomes agitated due to the severe redirection by the window and interaction with water already in the chamber. This randomizes (mixes) the water in the area where there is the highest UVC power.

The chamber is UVC-reflective. The top of the chamber may also be reflective or be another window injecting downward UVC light into the chamber.

Due to the vertical chamber and the acute redirection of water at the window, the disinfection efficiency is increased for the same UVC output power, resulting in potentially more throughput of water for the same disinfection percentage of water (e.g., 99%).

Identical disinfection systems may be connected in series (for increased disinfection) or in parallel (for increased throughput).

The UVC LED module (containing the UVC LEDs and window) may be screwed onto the end of the chamber for serviceability and/or to select the optimal UVC LEDs or output power for a particular application.

Numerous advantages exist over the prior art.

### BRIEF DESCRIPTION OF DRAWINGS

FIG. 1 is a cross-sectional view of a disinfection system described in Applicant's U.S. Pat. No. 9,540,252.

FIG. 2 is a cross-sectional view of a disinfection system in accordance with one embodiment of the invention.

FIG. 3 illustrates a UVC LED being optically coupled to a quartz window in the disinfection chamber via an index-matching soft silicone layer.

FIG. 4 illustrates the disinfection system of FIG. 2 but with a motorized cleaning brush attached to the top.

FIG. 5 is a top down, cross-sectional view of another embodiment of the disinfection system, showing an inlet coupled to a channel that spirals down into the disinfection chamber so that the fluid (e.g., water) swirls when it enters the chamber.

FIG. 6 illustrates multiple disinfection systems connected in series.

FIG. 7 illustrates multiple disinfection systems connected in parallel.

Elements in the various figures labeled with the same numerals may be the same or equivalent.

### DETAILED DESCRIPTION

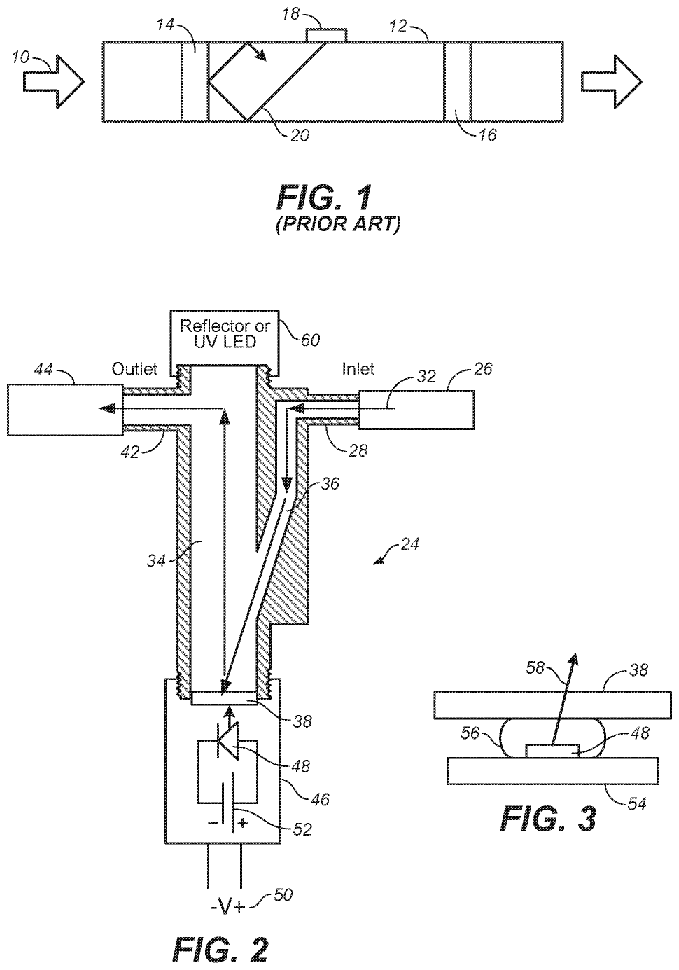

FIG. 2 illustrates one embodiment of a disinfection system 24. In one embodiment, the height of the disinfection system 24 is between 2-5 inches, and its vertical disinfection chamber diameter is about 1-2 inches. The shape may be generally cylindrical. The disinfection system 24 may be a plastic or metal.

A conventional water inlet pipe 26 is coupled to an inlet 28 of the disinfection system 24. The pipe 26 may be metal, PVC, or other suitable material. The water 32 may be under pressure. A filter may be inserted in the inlet 28 to filter out particles of any size.

The system 24 has an internal structure that guides the water 32 at a downward angle into a cylindrical disinfection chamber 34 into which UVC light is injected. The UVC light may have a peak wavelength of about 280 nm. Multiple UV LEDs may be used to increase the overall power output. Multiple UV LEDs may also be used to generate a variety of UV wavelengths to disinfect the water 32 or other fluid.

The pressurized water 32 increases its velocity due to the cross-section of the angled input channel 36 being less than that of the incoming pipe 26. The downward-flowing water 32 then enters the disinfection chamber 34 at an acute angle, such as less than 45 degrees, and preferably between 10-20 degrees, relative to a central axis of the chamber 34. The water 32 that enters the chamber 34 thus impinges on a transparent quartz window 38 at an angle almost perpendicular to its surface, under pressure, so that the incoming water 32 is exposed to the highest UV power.

The water 32 entering the chamber 34 is then highly agitated by the incoming water 32 being redirected (almost 180 degrees) by the quartz window 38 while coming into contact with water 32 already in the chamber 34.

The water 32 then flows generally vertically upward within the chamber 34 and is then redirected at the top of the chamber 34 to an outlet 42 and into an outlet pipe 44. The inlet 28 and outlet 42 are preferably coaxial.

The randomized water 32 within the chamber 32 is subjected to UVC light the entire time. A UV light module 46 contains one or more UVC LEDs 48 that are optically coupled to the quartz window 38. The threaded module 46 is screwed onto the bottom of the disinfection chamber 34 to allow easy serviceability or to enable selection of a particular UVC output power for a particular application, such as a desired fluid throughput or disinfection percentage of the water.

The UVC LEDs 48 may be powered by an external power source 50. The power source 50 also charges a rechargeable battery 52, which powers the UVC LEDs 48 in case of a power failure.

FIG. 3 shows how the UVC LEDs 48, mounted on an optionally reflective circuit board 54, may be optically coupled to the back surface of the quartz window 38 by an index-matching soft silicone 56. In index of refraction of the silicone 56 is between that of the UVC LEDs 48 and the quartz to reduce total internal reflection (TIR). The UVC LEDs 48 and circuit board 54 press the soft silicone 56 against the quartz surface so there is no air gap. The silicone 56 also helps to encapsulate the UVC LEDs 48. The transparent silicone 56 may be highly thermally conductive so as to optically and thermally couple the UVC LEDs 48 to the quartz window 38, which is also thermally conductive. In this way, the water removes heat from the UVC LEDs 48 along with the circuit board 54, which preferably has a metal core coupled to a heat sink.

Instead of, or in conjunction with, the circuit board 54 being reflective, the quartz window 38 may be coated with a top reflective surface so that the UVC light passes in one direction and is reflected in the other direction.

A UVC light ray 58 is shown exiting the quartz window 38 to enter the disinfection chamber 34 (FIG. 2).

The UVC LEDs 48 may be RayVio XD UV LEDs, emitting at 280 nm, whose data sheet is incorporated by reference.

The internal wall of the disinfection chamber 34 is reflective to UV light, such as by being coated with a UV-reflective Teflon. Such Teflon is available from Porex Inc. The inner wall may also be a polished metal, such as aluminum or stainless steel.

The top of the disinfection chamber 34 is sealed with another threaded module 60 that screws to the top. The module 60 may simply be a reflector or contain one or more additional UVC LEDs, identical to the module 46. The water 32 comes in contact with the upper window or reflector and is randomized due to the severe redirection, thus further disinfecting the water 32.

The disinfected water 32 in the chamber 34 is eventually removed at the outlet 42.

The generally vertical orientation of the disinfection chamber 34 ensures that there is little or no air between the quartz window 38 and the water 32 in the chamber 34. If there will be little or no air in the chamber 34, and the water 32 is under pressure, the chamber 34 does not have to be vertical.

Advantages of the system of FIG. 2 over that of a straight disinfection chamber, such as shown in FIG. 1, include the following:

1. Increased exposure of the water to UVC light due to the UVC light being directed along the central axis of the vertical disinfection chamber 34 where the water dwells before exiting.

2. Increased agitation of the water near the quartz window 38, due to the water being upwardly redirected by the quartz window 38 while water resides in the chamber 34, to randomize the water for enhanced UVC light exposure in the vicinity of the quartz window 38 where the UVC light is the most powerful.

3. Increased exposure of the water to the highest power UVC light by all the water initially impinging on the quartz window 38, where the UVC power is the highest.

4. Improved cleaning of the quartz window 38 by the water being forced onto the quartz window surface at an acute angle.

5. Selectability in the UVC power by enabling additional UVC LEDs, rather than just a reflector, to be mounted at the top of the disinfection chamber 34.

6. Reduced disinfection system size by providing a vertical disinfection chamber rather than a horizontal chamber as in FIG. 1, allowing the horizontal size of the disinfection system 24 to be on the order of 2 inches.

7. The water impinging on the quartz window removes heat from the UVC LEDs, thermally and optically coupled to the window.

Other advantages exist.

In one embodiment, it is desirable to expose the water to the UVC light for a minimum of 0.4 seconds to disinfect greater than 99% of the water. Due to the improvement in efficiency of the disinfection system of FIG. 2 over that of FIG. 1, it is estimated that more than twice as much water can be disinfected over a unit time compared to the system of FIG. 1 for the same output power of the UVC LEDs.

Different types of modules may be screwed on the top of the chamber 34 to replace the module 60. Such modules may be used for analyzing the water (e.g., for detecting water transparency), determining that the UVC LEDs in the bottom module 46 are emitting light, mixing the water, chemically treating the water, etc. In one embodiment the top module includes photodetectors for determining that the UVC LEDs are operating properly.

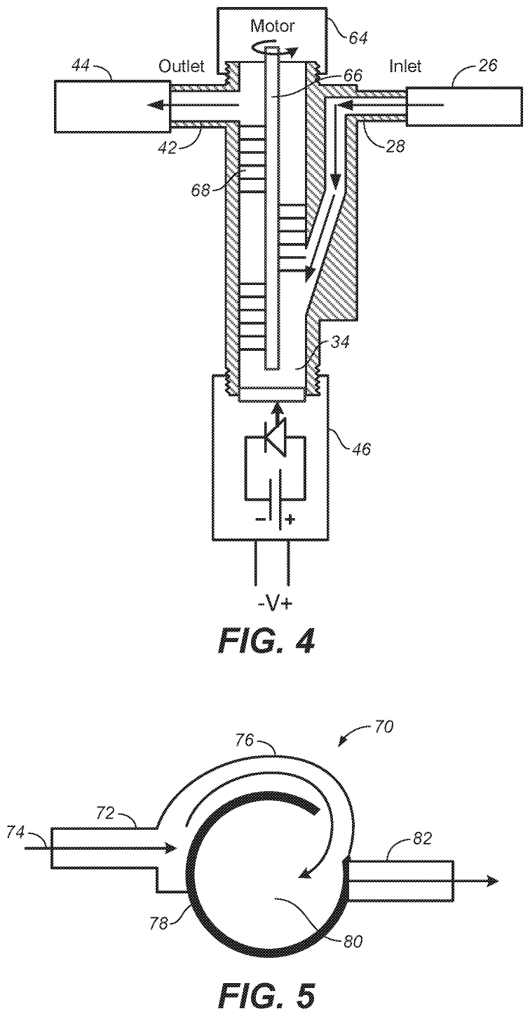

FIG. 4 shows an embodiment where the top module 60 is replaced by a motor 64 driving a shaft 66 having cleaning brushes 68. The rotating brushes 68 clean the inside wall of the chamber 34.

Multiple disinfection systems 24 may be vertically stacked upon each other by vertically connecting them to the threads, rather than using module 60. Any number of inlets and outlets may be used. UVC LEDs may be mounted on the bottom disinfection system and the top disinfection system to expose the water in the stacked chambers to UVC light.

Similarly, instead of module 60 screwed onto the top of the disinfection system 24, multiple different modules, performing different functions, may be connected in series on the top of the disinfection system 24. These series modules may enable the fluid to enter each of the modules for carrying out the associated functions. Such modules may include a water analysis module, a chemical treatment modules, a filter module, an auxiliary UVC disinfection module, etc.

In another embodiment, the disinfection system 24 may have any number of inlets and outlets along its length to improve throughput.

FIG. 5 illustrates another embodiment of a disinfection system 70. FIG. 5 is a top down, cross-sectional view of the disinfection system 70, showing an inlet 72, receiving water 74. The inlet 72 is coupled to a channel 76 that spirals down into the disinfection chamber 78 at an acute angle (e.g., less than 45 degrees) so that the water 76 swirls when it enters the chamber 78 and contacts the quartz window 80 due to the water 76 being injected across the quartz window 80 at an angle. The disinfected water 76 eventually exits through an outlet 82. This swirling action further randomizes the water proximate to the window 80 for increased exposure and efficiency.

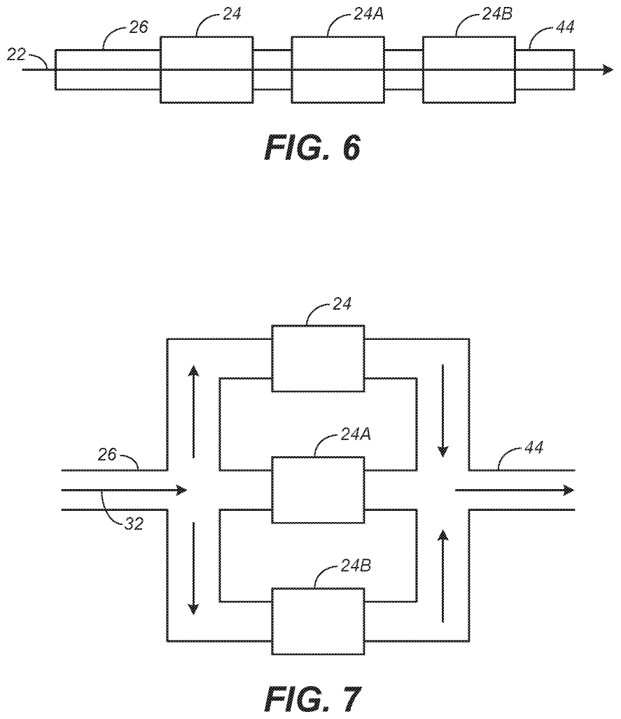

To increase the exposure time of the water to the UVC light, multiple disinfection systems 24 can be connected in series, as shown in FIG. 6 by the series-connected disinfection systems 24, 24A, and 24B. Any number of disinfection systems 24 can be connected in series. This allows each disinfection system 24 to be relatively inexpensive since they can be connected in series to achieve the desired disinfection performance.

To increase the throughput of water (or other fluid), multiple disinfection systems can be connected in parallel, as shown in FIG. 7 by the parallel-connected disinfection systems 24, 24A, and 24B. Any number of disinfection systems 24 can be connected in parallel.

Any water processing device, such as analyzers, chemical processors, etc., can be connected in series or parallel with the systems of FIG. 6 or 7, so the systems do not have to be directly connected to each other to be in series or parallel. Some of the systems in FIG. 6 or 7 may include in them different water processing devices, such as different modules 60 (FIG. 2). Different size systems may also be connected in series and parallel.

If multiple UVC LEDs are connected in one module and they are connected in series, the UVC LEDs should be designed to fail as a short so that the other UVC LEDs remain powered. High reliability is important.

Having described the invention in detail, those skilled in the art will appreciate that, given the present disclosure, modifications may be made to the invention without departing from the spirit of the inventive concept described herein. Therefore, it is not intended that the scope of the invention be limited to the specific embodiments illustrated and described.

What is claimed is:

1. A disinfection system for a fluid comprising:
a fluid inlet;
a fluid outlet;
a disinfection chamber having a transparent window at a first end of the chamber;
one or more UVC LEDs optically coupled to the transparent window for injecting UVC light into the chamber;
a first fluid channel that directs the fluid from the fluid inlet at an acute angle, relative to a central axis of the chamber, onto the transparent window; and
a second fluid channel that redirects the fluid from the chamber to the fluid outlet.

2. The system of claim 1 wherein the acute angle is less than 45 degrees relative to the central axis of the chamber.

3. The system of claim 1 wherein the acute angle is less than 20 degrees relative to the central axis of the chamber.

4. The system of claim 1 wherein the fluid inlet and the fluid outlet are substantially coaxial.

5. The system of claim 1 wherein the one or more UVC LEDs are part of a module that removably attaches to an end of the chamber.

6. The system of claim 5 wherein the module also includes the transparent window.

7. The system of claim 1 wherein the first fluid channel directs the fluid at the acute angle downward onto the transparent window while also directing the fluid across the transparent window such that the fluid swirls proximate to the transparent window.

8. The system of claim 1 wherein the transparent window is coupled to the chamber at a first end of the chamber, the system further comprising a removable module coupled to a second end of the chamber opposite to the first end of the chamber.

9. The system of claim 8 wherein the module includes a reflector.

10. The system of claim 8 wherein the module includes a second set of one or more UVC LEDs.

11. The system of claim 8 wherein the module includes a photodetector.

12. The system of claim 8 wherein the module includes a water analyzing device.

13. The system of claim 8 wherein the module chemically treats the fluid.

14. The system of claim 8 wherein the module includes a motorized brush for cleaning walls of the chamber.

15. The system of claim 1 wherein the one or more UVC LEDs are optically coupled to the transparent window via a soft transparent silicone.

16. The system of claim 1 wherein the transparent window forms at least a portion of one end of the chamber.

17. The system of claim 1 connected in series with one or more substantially identical systems.

18. The system of claim 1 connected in parallel with one or more substantially identical systems.

19. The system of claim 1 wherein the chamber is substantially cylindrical and the transparent window is round.

20. The system of claim 1 wherein the transparent window has a mirrored surface facing into the chamber so as to pass UVC light in one direction and reflect UVC light in the opposite direction.
